(19) United States
(12) Patent Application Publication
(10) Pub. No.: US 2017/0219147 A1
(43) Pub. Date: Aug. 3, 2017

(54) Method and Apparatus for Disconnection of Hoses and Other Conduits

(71) Applicant: Foley Patents, LLC, Abbevillela, IL (US)

(72) Inventor: Lawrence E. Foley, Lafayette, LA (US)

(73) Assignee: Foley Patents, LLC, Abbeville, LA (US)

(21) Appl. No.: 15/417,829

(22) Filed: Jan. 27, 2017

Related U.S. Application Data
(60) Provisional application No. 62/287,963, filed on Jan. 28, 2016.

(51) Int. Cl. F16L 37/32; F16L 15/00; F16L 37/02

(52) U.S. Cl. CPC F16L 37/32; F16L 37/02; F16L 15/006

(57) ABSTRACT

A disconnect assembly for operationally attaching a hose or other fluid conduit to a fluid inlet, and selectively decoupling the hose or conduit from the fluid inlet. In a first locked position, a fluid pressure seal is formed permitting pressurized flow of fluids through the disconnect assembly. In a second unlocked position, the hose or other fluid conduit can be quickly, safely and efficiently decoupled from the disconnect assembly such as, for example, during an emergency or unforeseen crisis. Following such decoupling, fluid is automatically contained and prevented from discharging into a surrounding environment.

### CROSS REFERENCES TO RELATED APPLICATION

PRIORITY OF U.S. PROVISIONAL PATENT APPLICATION SER. NO. 62/287,963, FILED JAN. 28, 2016, INCORPORATED HEREIN BY REFERENCE, IS HEREBY CLAIMED.

### STATEMENTS AS TO THE RIGHTS TO THE INVENTION MADE UNDER FEDERALLY SPONSORED RESEARCH AND DEVELOPMENT

NONE

### BACKGROUND OF THE PRESENT INVENTION

Field of the Invention

The present invention pertains to a fluid conduit disconnect assembly, primarily for use during emergency or unexpected disconnection operations. More particularly, the present invention pertains to an emergency disconnect assembly for use in quickly disconnecting at least one fluid conduit from an anchor point. More particularly still, the present invention pertains to an emergency hose disconnect assembly for use in quickly disconnecting at least one hose from a fluid inlet during an emergency situation such as, for example, when a boat is required to pull away from an offshore platform or other facility.

Brief Description of the Prior Art

During certain operations, a hose or other fluid conduit can be operationally attached to a plurality of anchor points; said hose can extend between said anchor points to accommodate the flow of fluids through such conduit. For example, in certain oil and gas drilling operations, hoses are frequently connected between a boat and a fluid inlet disposed on an offshore oil platform or other fixed structure. In one such operation, pumps are installed on a boat and fluid is pumped through a hose from a boat to a fluid inlet receptacle located on said platform.

In such situations, a boat can be tethered to a fixed structure or platform with a hose extending between said boat and said fixed structure/platform. However, in certain circumstances, such as when an emergency situation arises, said boat must be able to quickly move away from the structure/platform. As a result, the hose must be capable of being quickly disconnected from the boat and/or fluid inlet receptacle on said structure/platform, without causing damage to either.

Thus, there is a need for a disconnect assembly that permits a hose or other conduit to be quickly and safely disconnected from a boat and/or fluid inlet receptacle on a fixed structure/platform, without causing damage to said hose, boat or fixed structure/platform. Upon disconnection, said disconnect assembly should beneficially limit or restrict pollution from a disconnected hose or conduit into the surrounding environment.

### SUMMARY OF THE PRESENT INVENTION

In a preferred embodiment, a hose disconnect assembly of the present invention generally comprises an inlet assembly, an outlet assembly and an actuation assembly. Generally, said outlet assembly can be selectively received within an inlet connection receptacle of said inlet assembly and secured or locked in place using said actuation assembly.

Said outlet connection assembly can be connected to the distal end or outlet of a hose that extends from a boat to a fixed structure or platform (or other boat or vessel). When said outlet connection assembly is secured to said inlet connection assembly by said actuation assembly, a fluid pressure seal is formed between said outlet connection assembly and said inlet connection assembly. In this configuration, a fluid flow path defining a fluid pressure seal exists between a boat and a fixed structure or platform through said hose disconnect assembly.

In a preferred embodiment, said actuation assembly comprises at least one locking plate (typically a pair of locking plates comprising a right locking plate and a left locking plate) operationally attached to at least one fluid powered cylinder. Said at least one fluid powered cylinder is hydraulically or pneumatically actuated, thereby causing said at least one locking plate(s) to shift between “locked” and “unlocked” positions. Although other orientations can be envisioned without departing from the scope of the present invention, in a preferred embodiment, said fluid powered cylinder can be disposed vertically and comprises an extendable piston rod.

The disconnect assembly of the present invention may be fixed to a skid which is attached to the deck of a boat. During operation, a hose or other conduit can be operationally attached to said outlet assembly; said outlet assembly can be selectively received within said inlet connection receptacle of said inlet assembly and secured or locked in place using said actuation assembly. When disconnection of a hose between a boat and fixed structure is required (such as, for example, during an emergency situation), said actuation assembly can be actuated, thereby unlocking said outlet assembly from said inlet assembly and permitting removal of said outlet assembly.

In this manner, a hose or other conduit can be quickly and safely disconnected from a boat and/or fluid inlet receptacle on a fixed structure/platform, without causing damage to said hose, boat or fixed structure/platform. Upon disconnection, check valves in said inlet assembly and outlet assembly beneficially limit or restrict pollution from a disconnected hose or conduit into the surrounding environment.

### BRIEF DESCRIPTION OF THE DRAWINGS/FIGURES

The foregoing summary, as well as any detailed description of the preferred embodiments, is better understood when read in conjunction with the drawings and figures contained herein. For the purpose of illustrating the invention, the drawings and figures show certain preferred embodiments. It is understood, however, that the invention is not limited to the specific methods and devices disclosed in such drawings or figures.

FIG. 1 depicts a side perspective view of a preferred embodiment of a hose disconnect assembly of the present invention.

FIG. 2 depicts a side perspective view of a hose disconnect assembly of the present invention.

FIG. 3 depicts a side sectional view of a preferred embodiment of an inlet assembly and an outlet assembly of a hose disconnect assembly of the present invention in a connected configuration.

FIG. 4 depicts a side sectional view of a preferred embodiment of an inlet assembly and an outlet assembly of a hose disconnect assembly of the present invention in a disconnected configuration.

FIG. 5 depicts a side sectional view of a preferred embodiment of an inlet assembly of the present invention with a closed internal check valve.

FIG. 6A depicts a side view of a preferred embodiment of an outlet assembly of the present invention.

FIG. 6B depicts an end view of a preferred embodiment of an outlet assembly of the present invention.

FIG. 7A depicts a front view a first locking plate of the present invention.

FIG. 7B depicts an end view a first locking plate of the present invention.

FIG. 8A depicts a side partially cut-away view of a hose disconnect assembly of the present invention in a locked position.

FIG. 8B depicts a side view of a hose disconnect assembly of the present invention in an unlocked position.

### DETAILED DESCRIPTION OF A PREFERRED EMBODIMENT

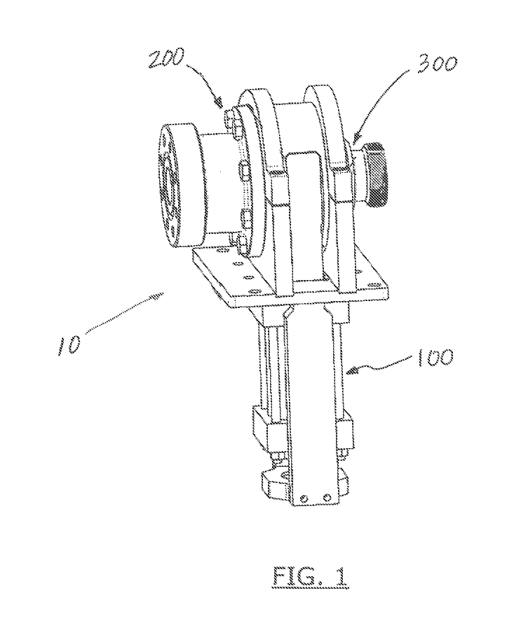

Referring to the drawings, FIG. 1 depicts a side perspective view of a preferred embodiment of a hose disconnection assembly 10 of the present invention. As depicted in FIG. 1, disconnect assembly 10 further comprises actuation assembly 100, inlet assembly 200 and outlet assembly 300. Said disconnect assembly 10 generally comprises a point of operational attachment for a pump or other fluid handling equipment, typically located on a boat or other movable vessel, to selectively connect with a hose or other fluid conduit.

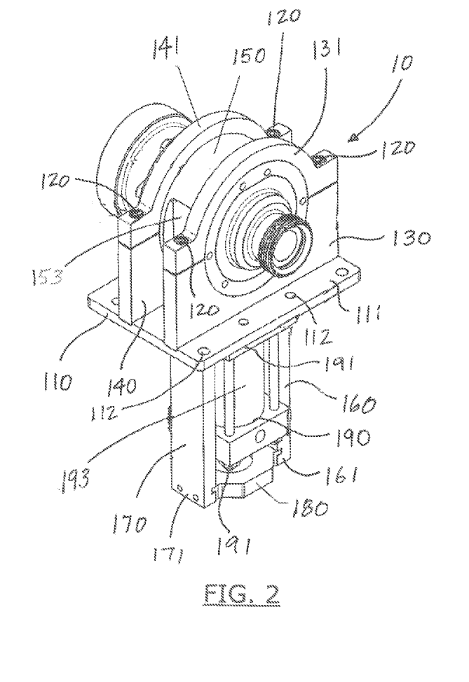

FIG. 2 depicts a side perspective view of a preferred embodiment of a hose disconnect assembly 10 of the present invention generally comprising actuation assembly 100, inlet assembly 200 and outlet assembly 300. Actuation assembly 100 generally comprises base plate 110 having upper surface 111 and a plurality of apertures 112 for receiving fasteners such as threaded bolts (not shown in FIG. 1) securing said base plate 110 to a desired mounting structure or substrate. Substantially planar clamp plates 130 and 140 extend from said upper surface 111 of base plate 110; in a preferred embodiment, said clamp plates 130 and 140 are oriented substantially perpendicular to base plate 110 and parallel to each other.

Central housing 150 is disposed between said clamp plates 130 and 140. Collar bracket 131 secures said central housing 150 to clamp plate 130, while collar bracket 141 secures said central housing 150 to clamp plate 140. In a preferred embodiment, said collar brackets 131 and 141 have a substantially concave shape to frictionally fit on the curved outer surface of central housing 150. Collar brackets 131 and 141 are each secured to their respective clamp plates 130 and 140, respectively, using threaded fasteners 120. Central housing 150 has elongate slot 153 oriented tangentially to its outside diameter; although not visible in FIG. 2, an opposing elongate slot is disposed on the opposite side of central housing 150 from slot 153.

Although other orientations can be utilized without departing from the scope of the present invention, it is to be observed that in many operational installations base plate 110 is oriented in a substantially horizontal orientation, while clamp plates 130 and 140 are oriented in a substantially vertical orientation. In this configuration, elongate slot(s) 153 are oriented in a substantially vertical direction.

Still referring to FIG. 2, fluid powered cylinder 190 has a central barrel 193 and base 191 which is beneficially mounted under base plate 110. Piston rod 192 can extend from, or retract into, said central barrel 193 of fluid powered cylinder 190. Connector plate 180 is operationally attached to the distal end of said piston rod 192, while locking plates 160 and 170 are attached to connector plate 180 at bottom ends 161 and 171, respectively. Extension of piston rod 191 of fluid powered cylinder 190 generally causes connector plate 180 to move in a direction away from base plate 110, while retraction of said piston rod 191 of fluid powered cylinder 190 generally causes connector plate 180 to move in a direction toward base plate 110.

Fluid powered cylinder 190 is beneficially depicted as a hydraulically-powered cylinder; however, it is to be understood that another type of fluid powered cylinder (such as a pneumatically-powered cylinder) can be used in place of said hydraulic fluid powered cylinder 190 without departing from the scope of the present invention. Alternatively, a linear actuator (such as, for example, an electric-powered linear actuator) could also be used in certain operational environments.

Still referring to FIG. 2, actuation of fluid powered cylinder 190 causes piston rod 191 to extend from the barrel of said cylinder 190. Such extension forces connector plate 180 to travel in a direction generally away from base plate 110. Although not visible in FIG. 2, said locking plates 160 and 170 are slidably received in slots passing through base plate 110. Because locking plates 160 and 170 are operationally attached to connector plate 180 (at bottom ends 161 and 171, respectively), extension/retraction of piston rod 191 of fluid powered cylinder 190 also forces locking plates 160 and 170 to shift in an axial direction perpendicular to base plate 110; said locking plates 160 and 170 travel relative to the sides of central housing 150 within slots 153.

In many conventional installations, said fluid powered cylinder 190 is disposed vertically below base plate 110. In such circumstances, piston rod member 191 travels in a relatively downward direction when said cylinder 190 is extended by a pressurized hydraulic fluid source (not shown), thereby causing said locking plates 160 and 170 to be shifted in a relatively downward direction within slots 153 of said housing member 150. Conversely, piston rod member 191 can retract in a relatively upward direction when said cylinder 190 is retracted, thereby causing locking plates 160 and 170 to shift in a relatively upward direction within slots 153 of said housing member 150.

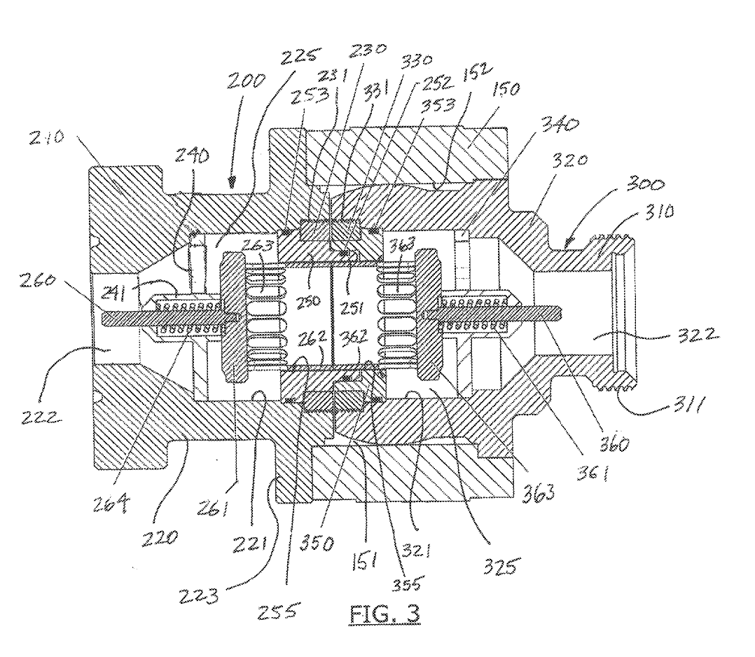

FIG. 3 depicts a side sectional view of a preferred embodiment of an inlet assembly 200 and outlet assembly 300 of a hose disconnect assembly 10 of the present invention in a connected configuration. Inlet assembly 200 generally comprises body member 220 having an internal chamber 225 defining inner surface 221. Inlet connection member 210 is attached to said body member 220, while passage 222 extends through said connection member 210 and is in fluid communication with said inner chamber 225 of said body member 220. Said connection member 210 can comprise a bolted flange member or other conventional connection means designed for sealably attaching said inlet assembly 200 to a fluid conduit or other fluid handling equipment.

Inlet seal gland 250 having boss 251 is at least partially concentrically disposed within said internal chamber 225 of body member 220 of inlet assembly 200. A first elastomeric seal member—in this case O-ring 252—is disposed within a groove on the outer surface of said boss 251 and effects a seal between said boss 251 of inlet seal gland 250 and the inner surface of outlet seal gland 350, discussed below. A second elastomeric seal member—in this case O-ring 253—is disposed within a groove on the external surface of inlet seal gland 250 and effects a seal between said inlet seal gland 250 and inner surface 221 of the internal chamber of body member 220. Said inlet seal gland 250 is held in place within said internal chamber using threaded retaining ring 230 having external threads 231.

Base plate 240 having elongate bore 241 is disposed within central internal chamber 225 of body member 220. In a preferred embodiment, the longitudinal axis of said elongate bore 241 is coaxial with the central longitudinal axis of body member 220. Valve rod 260 is slidably disposed within bore 241, and operationally attaches to valve base plate 261. Valve base plate 261 is operationally attached to perforated valve sleeve 262 which, in turn, is slidably disposed within inner bore 255 of inlet seal gland 250. Perforated valve sleeve 262 has a plurality of flow apertures 263 extending through said valve sleeve 262 around the circumference of said cylindrical valve sleeve 262. Compression spring 264 is disposed within bore 241 and biases valve base plate 261 toward inlet seal gland 250 (that is, in a closed position). Central housing 150 is attached to flange 223 of body member 220; said central housing 150 has a central bore 151 defining inner surface 152.

Still referring to FIG. 3, outlet assembly 300 generally comprises body member 320 having an internal chamber 325 defining an inner surface 321. Inlet connection member 310 is attached to said body member 320, while passage 322 extends through said connection member 310 and leads to said inner chamber 325 of said body member 320. Said connection member 310 can have external threads 311 or other conventional connection means for sealably attaching said out assembly 300 to a hose or other fluid conduit.

Outlet seal gland 350 is at least partially concentrically disposed within the internal chamber 325 of outlet assembly 300. A first elastomeric seal member—in this case O-ring 353—is disposed within a groove on the outer surface of outlet seal gland 350 and effects a seal between said outlet seal gland 350 and inner surface 321of internal chamber 325 of body member 320. Said inlet seal gland 350 is held in place within said internal chamber using retaining ring 330 having external threads 331.

Base plate 340 having elongate bore 341 is disposed within the central internal chamber 325 of body member 320. In a preferred embodiment, the longitudinal axis of said elongate bore 341 is coaxial with the central longitudinal axis of body member 320. Valve rod 360 is slidably disposed within bore 341, and operationally attaches to valve base plate 361. Valve base plate 361 is operationally attached to perforated valve sleeve 362 which, in turn, is slidably disposed within an inner bore 355 of oultet seal gland 350. Perforated valve sleeve 362 has a plurality of flow apertures 363 extending through said valve sleeve 362 around the circumference of said sleeve 362. Compression spring 364 is disposed within bore 341 and biases valve base plate 361 toward outlet seal gland 350 (that is, in a closed position).

In the configuration depicted in FIG. 3, inlet assembly 200 and outlet assembly 300 are joined together in opposing end-to-end relationship. As depicted in FIG. 3, the leading edges of perforated valve sleeves 262 and 362 contact each other, thereby resulting in compression of compression springs 264 and 364. As said springs 264 and 364 compress, valve rods 260 and 360 travel axially outward within bores 264 and 364, respectively. This allows valve base plate 261 to move away from inlet seal gland 250, thereby exposing apertures 264, while simultaneously causing valve base plate 361 to move away from outlet seal gland 350, thereby exposing apertures 364. In this configuration, a substantially continuous fluid flow path is established through disconnect assembly 10; namely, fluid can flow through bore 322, perforated valve base plate 340, chamber 325, exposed apertures 363, sleeve 362, sleeve 262, exposed apertures 263, chamber 225, perforated valve base plate 240, and passage 222 (and vice versa).

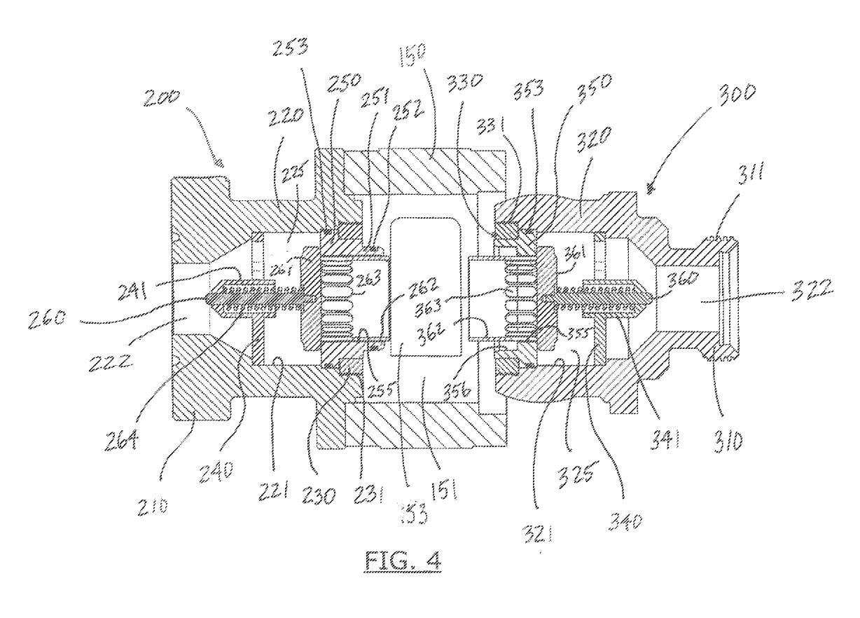

FIG. 4 depicts a side sectional view of a preferred embodiment of an inlet assembly 200 and outlet assembly 300 of a hose disconnect assembly 10 of the present invention in a disconnected configuration. As noted above, inlet assembly 200 generally comprises body member 220 having an internal chamber 225 defining an inner surface 221. Inlet connection member 210 is attached to said body member 220, while passage 222 extends through connection member 210 and leads to said inner chamber 225 of said body member 220.

Inlet seal gland 250 having boss 251 is concentrically disposed at least partially within the internal chamber 225 of inlet assembly 200. O-ring 252 is disposed within a groove on the outer surface of said boss 251, while O-ring 253 is disposed within a groove on the external surface of inlet seal gland 250. O-ring 253 effects a seal between said inlet seal gland 250 and inner surface 221 of the internal chamber of body member 220. Said inlet seal gland 250 is held in place within said internal chamber using threaded retaining ring 230.

Perforated base plate 240 having elongate bore 241 is disposed within the central inner chamber 225 of body member 220. Valve rod 260 is slidably disposed within bore 241, and operationally attaches to valve base plate 261. Valve base plate 261 is operationally attached to perforated valve sleeve 262 which is slidably disposed within inner bore 255 of inlet seal gland 250. Perforated valve sleeve 262 has a plurality of flow apertures 263 extending through said valve sleeve 262, while compression spring 264 is disposed within bore 241 and biases valve base plate 261 toward inlet seal gland 250.

Outlet assembly 300 generally comprises body member 320 having an internal chamber 325 defining an inner surface 321. Inlet connection member 310 having external threads 311 is attached to said body member 320, while passage 322 extends through said connection member 310 and leads to said inner chamber 325 of said body member 320.

Outlet seal gland 350 is at least partially concentrically disposed within the internal chamber 325 of outlet assembly 300. O-ring 353 is disposed within a groove on the outer surface of outlet seal gland 350 and effects a seal between said outlet seal gland 350 and inner surface 321of internal chamber 325 of body member 320. Inlet seal gland 350 is held in place within said internal chamber 325 using retaining ring 330 having external threads 331.

Ported or perforated base plate 340 having elongate bore 341 is disposed within the central internal chamber 325 of body member 320. Valve rod 360 is slidably disposed within bore 341, and operationally attaches to valve base plate 361. Valve base plate 361 is operationally attached to perforated valve sleeve 362 which, in turn, is slidably disposed within an inner bore 355 of outlet seal gland 350. (Outlet seal gland 350 also has a larger diameter bore 356 for receiving boss 225 of inlet seal gland 250, as discussed below). Perforated valve sleeve 362 has a plurality of flow apertures 363 extending through said valve sleeve 362 around the circumference of said sleeve 362. Compression spring 364 is disposed within bore 341 and biases valve base plate 361 toward outlet seal gland 350 (that is, in a closed position).

In the configuration depicted in FIG. 4, outlet assembly 300 is substantially removed from central bore 151 of housing 150; as such, unlike the configuration depicted in FIG. 3, inlet assembly 200 and outlet assembly 300 are not joined together in opposing end-to-end relationship. Because the leading edges of perforated valve sleeves 262 and 362 do not contact each other, compression spring 264 biases valve base 261 against inlet seal gland 250, while compression spring 364 biases valve base 361 against outlet seal gland 350. This allows apertures 263 of valve sleeve 262 to retract within inner bore 255, and valve base plate 261 to form a fluid seal against inlet seal gland 250. Similarly, this also allows apertures 363 of valve sleeve 362 to retract within inner bore 355, and valve base plate 361 to form a fluid seal against inlet seal gland 350.

As such, in the configuration depicted in FIG. 4, fluid entering inlet assembly 200 via passage 222 is prevented from flowing past said fluid seal formed by closed valve base plate 261 and inlet seal gland 250. Similarly, fluid entering outlet assembly 300 via passage 322 is prevented from flowing past said fluid seal formed by closed valve base plate 361 and inlet seal gland 350. In this manner, in the event that outlet assembly 300 is removed from bore 151 of housing 150, said fluid seals act as check valves, preventing unwanted spillage or escape of significant volumes of liquid from both inlet assembly 200 and outlet assembly 300.

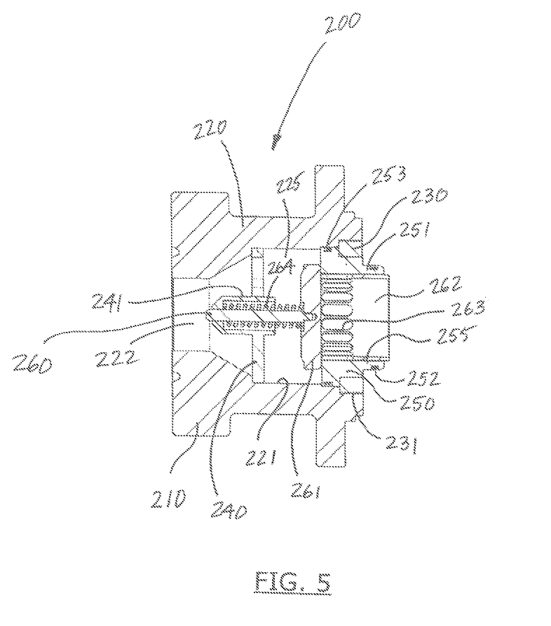

FIG. 5 depicts a side sectional view of a preferred embodiment of an inlet assembly 200 of the present invention with a closed internal check valve. Inlet assembly 200 generally comprises body member 220 having an internal chamber 225 defining an inner surface 221. Inlet connection member 210 is attached to said body member 220, while passage 222 extends through connection member 210 and is in fluid communication with inner chamber 225 of said body member 220.

Inlet seal gland 250 having boss 251 is concentrically disposed at least partially within the internal chamber 225 of inlet assembly 200. O-ring 252 is disposed within a groove on the outer surface of said boss 251, while O-ring 253 is disposed within a groove on the external surface of inlet seal gland 250. O-ring 253 effects a seal between said inlet seal gland 250 and inner surface 221 of the internal chamber of body member 220. Said inlet seal gland 250 is held in place within said internal chamber using threaded retaining ring 230 having external threads 231.

Ported or perforated base plate 240 having elongate bore 241 is disposed within the central inner chamber 225 of body member 220. Valve rod 260 is slidably disposed within bore 241, and operationally attaches to valve base plate 261. Valve base plate 261 is operationally attached to perforated valve sleeve 262 which is slidably disposed within inner bore 255 of inlet seal gland 250. Perforated valve sleeve 262 has a plurality of flow apertures 263 extending through said valve sleeve 262. Compression spring 264 is at least partially disposed within bore 241 and biases valve base plate 261 toward inlet seal gland 250. In the configuration depicted in FIG. 5, apertures 263 of valve sleeve 262 are fully retracted within said inner bore 255 of inlet seal gland 250, and valve base plate 261 forms a fluid seal against said inlet seal gland 250, thereby preventing fluid from flowing between valve base plate 261 and inlet seal gland 250.

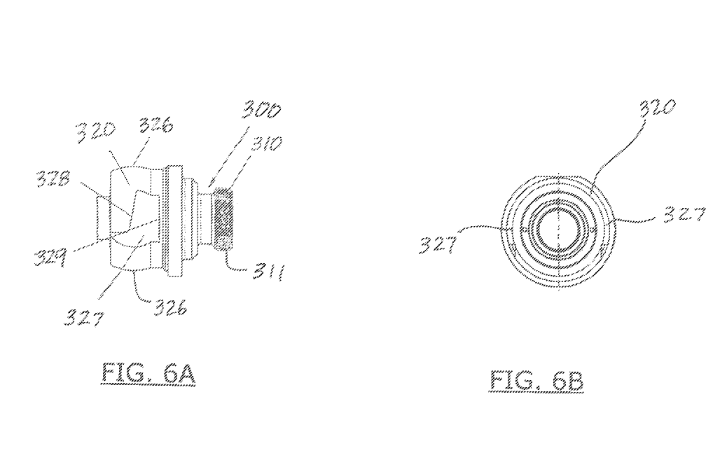

FIG. 6A depicts a side view of a preferred embodiment of an outlet assembly 300 of the present invention, while FIG. 6B depicts an end view of a preferred embodiment of said outlet assembly 300 of the present invention. Outlet body member 320 has outlet connection 310, and a substantially curved (convex) external surface 326. Body member 320 has lateral slots or recesses 327 which are diametrically disposed to each other and oriented tangentially to the outside diameter of outlet body 320. Each lateral slot 327 has an angled surface 328 and an opposing substantially vertical surface 329. Referring to FIG. 6B, it is to be observed that lateral slots 327 are disposed on opposite sides of body member 320.

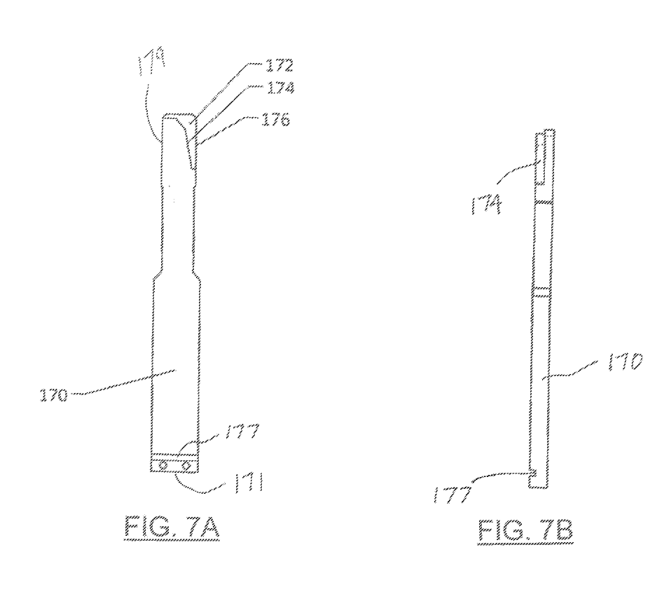

FIG. 7A depicts a front view a first locking plate 170 of the present invention, while FIG. 7B depicts an end view a first locking plate 170 of the present invention. Referring back to FIG. 2, locking plate 160 is a mirror image of locking plate 170 depicted in FIGS. 7A and 7B. Locking plate 170 has two parallel substantially vertical surfaces 176 and slot 172. Slot 172 has angled surface 174. The angle inscribed between angled surface 174 and vertical face 176 matches the angle inscribed between angled surface 328 and vertical surface 329 of outlet body 320 (depicted in FIG. 6A). Groove 177 is provided near base 171 to permit attachment to connector plate 180 (as depicted in FIG. 2).

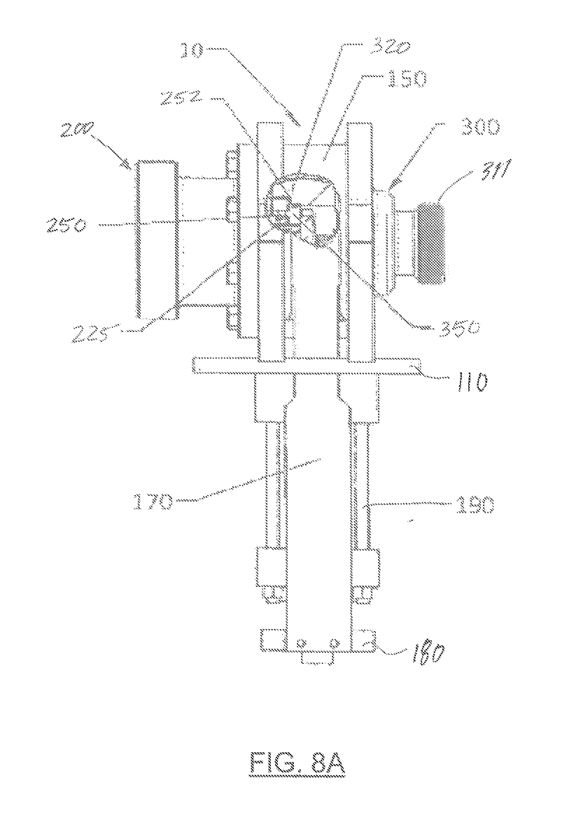

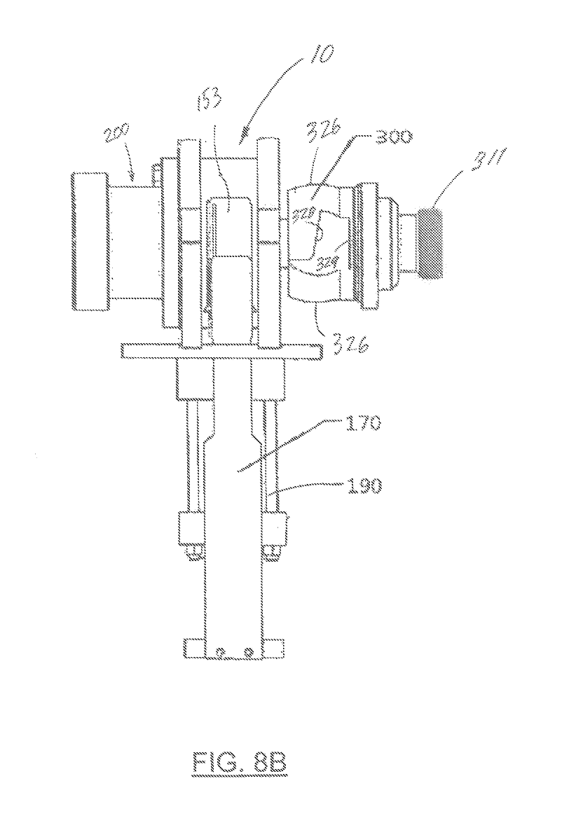

FIG. 8A depicts disconnect assembly 10 in a “locked” position. In said “locked” position, outlet assembly 300 is retained within housing 150 by opposing locking plates (locking plate 170, and an opposing locking plate 160, not visible in FIG. 8A but visible in FIG. 2). Boss 225 of inlet seal gland 250 is disposed within a bore (bore 356, depicted in FIG. 2) of outlet seal gland 350. As such, O-ring 252 of inlet assembly 200 effects a seal between inlet seal gland 250 and outlet seal gland 350. As such, fluid pressure is contained within disconnect assembly 10 in such connected and locked position.

Still referring to FIG. 8A, fluid powered cylinder 190 is disposed vertically below stationary base plate 110. Retraction of fluid powered cylinder 190 causes connector plate 180 and attached locking plate 170 (and opposing locking plate 160, not visible in FIG. 8A) to be shifted in a relatively upward direction. Said locking plates travel within slots 153 disposed on both lateral sides of said housing member 150 (as depicted in FIG. 4) and are partially received within recesses 327 disposed on both lateral sides of outlet assembly 300.

In this position, the angle inscribed between angled surface 174 and vertical face 176 of locking plate 170 (depicted in FIG. 7A) matches the angle formed between angled surface 328 and vertical surface 329 of outlet body 320 (depicted in FIG. 6A). Although not visible in FIG. 8A, locking plate 160 similarly engages and locks against outlet body 320 on the opposites side of said outlet body 320. In this manner, outlet assembly 300 is secured in place by said locking plates 170 and 160, thereby preventing said outlet assembly 300 from being removed or separated from housing 150, even with the application of axial force (such as, for example, tensile or pulling force applied to a hose or conduit attached to connection threads 311 of said outlet assembly 300).

FIG. 8B depicts disconnect assembly 10 in an “unlocked” position. Extension of fluid powered cylinder 190 causes connector plate 180 and attached locking plate 170 (and opposing locking plate 160, not visible in FIG. 8A) to be shifted in a relatively downward direction. Said locking plates travel within slots 153 disposed on both lateral sides of said housing member 150. In this position, locking plate 170 is removed from the space between angled surface 328 and vertical surface 329 of outlet body 320. Similarly, opposing locking plate 160 is also disengaged from outlet body 320 on the opposite side of said outlet body 320.

In this manner, outlet assembly 300 is no longer secured in place by said locking plates 170 and 160, thereby allowing said outlet assembly 300 to be removed or separated from housing 150. In said “unlocked” position, outlet assembly 300 is free of disconnect assembly 10; curved or convex outer surfaces 326 promote decoupling of outlet assembly 300 from housing 150 and prevent said outlet assembly 300 from becoming wedged or frictionally stuck within said housing 150, especially when said outlet assembly 300 is exposed to transverse loading during the disconnection process. A hose or other conduit (not shown) attached to threaded connection 311 of said outlet assembly 300 may fall overboard, such as when a boat departs a location. Internal check valve assemblies described herein prevent undesired loss or spillage of fluid into a surrounding environment from both inlet assembly 200 and outlet assembly 300.

In operation, disconnect assembly 10 of the present invention may be fixed to a skid which is attached to the deck of a boat or other vessel; notwithstanding the foregoing, it is to be observed that said disconnect assembly 10 can be disposed on other structures or locations without departing from the scope of the present invention. A pump, fluid source or other fluid handling equipment can be connected to inlet assembly 200 via connection member 201, while a hose or other conduit can be operationally attached to outlet assembly 300 via connection member 310 (including, without limitation, external threads 311 thereof).

Said hose can extend to a fluid storage tank or other fluid handling equipment situated on an offshore platform, fixed structure, or even another boat or vessel, and can act as a conduit for the flow of fluids from one location to another. Outlet assembly 300 can be selectively received within housing 150 of inlet connection 200, and secured or locked in place with actuation assembly 100 as depicted in FIG. 8A. For example, said hose or conduit can extend between said boat and a fixed structure (or another boat or vessel) when it is desirable to transfer fluid through said hose.

When disconnection of said hose is desired (such as, for example, during an emergency situation when said boat or vessel must move away from said fixed structure), said actuation assembly 100 can be actuated, thereby unlocking said outlet assembly 300 from said inlet assembly 200 as depicted in FIG. 8B. In this position, removal of said outlet assembly 300 from housing 150 of inlet assembly 200 is possible.

The design of disconnect assembly 10 permits quick, efficient, and inexpensive repair and/or re-dressing of assemblies or components of the present invention (including, without limitation, inlet assembly 200, outlet assembly 300 and actuation assembly 100) without specialized tools or training. Further, referring to FIG. 3, removal of retaining ring 230 permits easy access to internal check valve components of inlet assembly 200, while removal of retaining ring 330 permits easy access to internal check valve components of outlet assembly 300, such as when repair or part replacement is required. Additionally, removal of said retainer rings permits removal of said inlet and/or outlet internal check valve components when escape of fluids upon disconnection is not a concern (such as, for example, when a non-harmful gas can escape into the atmosphere).

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

What is claimed:

1. An assembly for selectively disconnecting a hose from a fluid inlet comprising:
a) an inlet assembly having a housing defining an internal chamber;
b) an outlet assembly operationally attached to a distal end of said hose, wherein said outlet assembly is removably received within said internal chamber; and
c) an actuation assembly for selectively securing said inlet assembly within said internal chamber.
